(19) United States
(12) Patent Application Publication
(10) Pub. No.: US 2016/0312654 A1
(43) Pub. Date: Oct. 27, 2016

(54) TURBINE AIRFOIL COOLING

(71) Applicant: UNITED TECHNOLOGIES CORPORATION, Farmington, CT (US)

(72) Inventors: Pritchaiah Vijay Chakka, Avon, CT (US); Andrew S. Aggarwala, Vernon, CT (US); Thomas J. Praisner, Colchester, CT (US); Brandon W. Spangler, Vernon, CT (US)

(21) Appl. No.: 15/105,443

(22) PCT Filed: Dec. 19, 2014
(86) PCT No.: PCT/US2014/071582

§ 371 Date: Jun. 16, 2016

Related U.S. Application Data
(60) Provisional application No. 61/918,478, filed on Dec. 19, 2013.

(51) Int. Cl. F01D 25/12; F01D 9/02; F02C 3/04; F01D 5/12

(52) U.S. Cl. CPC F01D 25/12; F01D 5/12; F01D 9/02; F02C 3/04; F05D 2220/323; F05D 2240/35; F05D 2260/20

(57) ABSTRACT

An airfoil assembly has at least one cooling hole in an aft edge of at least one platform for cooling at least one of an axially downstream airfoil root and/or tip region. The airfoil assembly may be a high pressure turbine first stage vane coupled with a combustor operating at a low Pattern Factor.

This application claims priority to U.S. Patent Appln. No. 61/918,478 filed Dec. 19, 2013.

### BACKGROUND

The present disclosure relates to a gas turbine engine and, more particularly, to an airfoil assembly utilized to cool axially downstream airfoils.

Gas turbine engines, such as those that power modern commercial and military aircraft, include a fan section to propel the aircraft, compressor section to pressurize a supply of air from the fan section, a combustor section to burn a hydrocarbon fuel in the presence of the pressurized air, and a turbine section to extract energy from the resultant combustion gases and generate thrust.

The combustor section serves to combine and mix the air and fuel entering the combustor, ignite the mixture, contain the mixture during the combustion process and tailor the temperature distribution of the resultant hot gases at an exit plane of the combustor section. To protect the turbine section it is desirable to reduce combustor exit mean temperatures of the hot combustor gases and to design the turbine section to accept pre-established exit temperature profiles across the exit plane of the combustor section. In a traditional sense, turbine section designs strive to reduce the temperature distribution at a most radial inward location to protect the turbine blade attachment to the shaft, and is also reduced at a most radial outward location to protect or manage the blade tip clearance to a wall.

One means of profiling the temperature distribution is called the “Pattern Factor.” The Pattern Factor reflects the extent to which the maximum temperature of the distribution deviates from the average temperature rise across the combustor exit plane. Traditionally, the Pattern Factor is relatively high to protect the blade root and tip; however, for desired combustor sections with a low Pattern Factor, alternative means of protecting or cooling the blade root and tip is desirable.

### SUMMARY

An airfoil assembly according to one non-limiting embodiment of the present disclosure includes a first platform having an aft edge and a cooling hole communicating through the aft edge, and an airfoil projecting outward from the first platform.

In a further embodiment of the foregoing embodiment the first platform is an inner platform.

In the alternative or additionally thereto, in the foregoing embodiment the airfoil assembly is a blade.

In the alternative or additionally thereto, in the foregoing embodiment the cooling hole is angled circumferentially.

In the alternative or additionally thereto, in the foregoing embodiment the airfoil assembly includes a second platform wherein the airfoil spans between the first and second platforms, and the assembly is a vane.

In the alternative or additionally thereto, in the foregoing embodiment the aft cooling hole is one of a plurality of cooling holes spaced along the aft edge.

In the alternative or additionally thereto, in the foregoing embodiment the airfoil assembly includes a second aft edge of the second platform, and at least one cooling hole communicating through the second aft edge.

In the alternative or additionally thereto, in the foregoing embodiment the airfoil assembly is a first stage vane.

A gas turbine engine according to another non-limiting embodiment of the present disclosure includes a combustor constructed and arranged to produce hot combustor gases; a turbine disposed aft of the combustor and having a vane for directing the hot combustor gases and a blade disposed aft of the vane; and wherein the vane has a platform having an aft edge and a cooling hole communicating through the aft edge for cooling the blade.

In a further embodiment of the foregoing embodiment, the hot combustor gases have a low Pattern Factor.

In the alternative or additionally thereto, in the foregoing embodiment the platform is an inner platform, and a root region of the blade is disposed downstream of and proximate to the aft edge.

In the alternative or additionally thereto, in the foregoing embodiment the platform is an outer platform, and a tip region of the blade is disposed downstream of and proximate to the aft edge.

In the alternative or additionally thereto, in the foregoing embodiment the vane has an airfoil and a second platform wherein the airfoil spans radially between the platform and the second platform, and the second platform has an aft edge and a cooling hole communicating through the aft edge of the second platform.

In the alternative or additionally thereto, in the foregoing embodiment the vane and blade are a high pressure turbine first stage vane and blade.

A method of cooling a turbine airfoil according to another non-limiting embodiment of the present disclosure includes the steps of flowing cooling air through a hole in an aft edge of a platform of an airfoil assembly disposed upstream of the airfoil.

In a further embodiment of the foregoing embodiment the method includes the additional step of cooling a root region of the airfoil.

In a further embodiment of the foregoing embodiment the airfoil is a blade and the airfoil assembly is a vane.

In the alternative or additionally thereto, in the foregoing embodiment the method includes the additional step of cooling a tip region of the blade.

In the alternative or additionally thereto, in the foregoing embodiment the method includes the additional step of cooling a tip region of the airfoil.

The foregoing features and elements may be combined in various combination without exclusivity, unless expressly indicated otherwise. These features and elements as well as the operation thereof will become more apparent in light of the following description and the accompanying drawings. It should be understood, however, the following description and figures are intended to exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic cross-section of an exemplary gas turbine engine;

FIG. 2 is a cross-section of a combustor section;

FIG. 3 is a graph of temperature profiles;

FIG. 4 is a partial perspective view of an exemplary gas turbine engine with portions removed to show internal detail;

FIG. 5 is a perspective view of a high pressure turbine vane of the gas turbine engine and as one non-limiting example of an airfoil assembly;

FIG. 6 is a partial schematic of a first stage of the high pressure turbine;

FIG. 7 is a perspective view of a second embodiment of the airfoil assembly; and

FIG. 8 is a partial schematic of a turbine section having both the first and second embodiments of the airfoil assembly.

### DETAILED DESCRIPTION

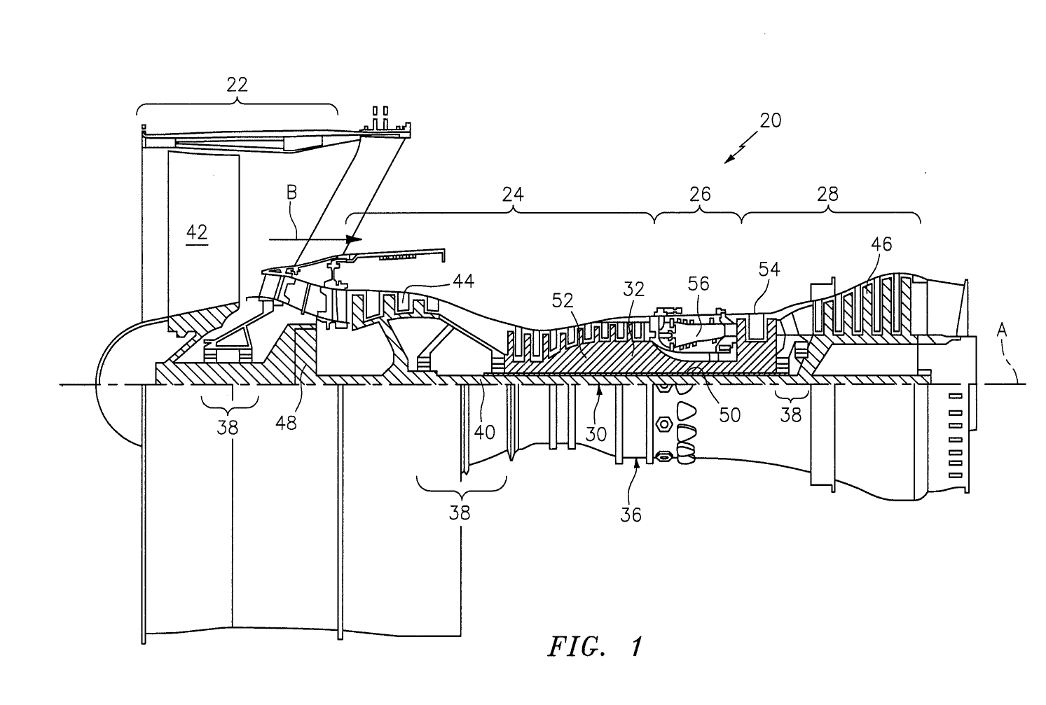

FIG. 1 schematically illustrates a gas turbine engine 20 disclosed as a two-spool turbo fan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan in the disclosed non-limiting embodiment, it should be understood that the concepts described herein are not limited to use with turbofans as the teachings may be applied to other types of turbine engine architecture such as turbojets, turboshafts, and three-spool (plus fan) turbofans with an intermediate spool.

The engine 20 generally includes a low spool 30 and a high spool 32 mounted for rotation about an engine central longitudinal axis A relative to an engine static structure 36 or engine case via several bearing structures 38. The low spool 30 generally includes an inner shaft 40 that interconnects a fan 42 of the fan section 22, a low pressure compressor 44 (“LPC”) of the compressor section 24 and a low pressure turbine 46 (“LPT”) of the turbine section 28. The inner shaft 40 drives the fan 42 directly or through a geared architecture 48 to drive the fan 42 at a lower speed than the low spool 30. An exemplary reduction transmission is an epicyclic transmission, namely a planetary or star gear system.

The high spool 32 includes an outer shaft 50 that interconnects a high pressure compressor 52 (“HPC”) of the compressor section 24 and high pressure turbine 54 (“HPT”) of the turbine section 28. A combustor 56 of the combustor section 26 is arranged between the HPC 52 and the HPT 54. The inner shaft 40 and the outer shaft 50 are concentric and rotate about the engine axis A. Core airflow is compressed by the LPC 44 then the HPC 52, mixed with the fuel and burned in the combustor 56, then expanded over the HPT 54 and the LPT 46. The LPT 46 and HPT 54 rotationally drive the respective low spool 30 and high spool 32 in response to the expansion.

In one non-limiting example, the gas turbine engine 20 is a high-bypass geared aircraft engine. In a further example, the gas turbine engine 20 bypass ratio is greater than about six (6:1). The geared architecture 48 can include an epicyclic gear train, such as a planetary gear system or other gear system. The example epicyclic gear train has a gear reduction ratio of greater than about 2.3:1, and in another example is greater than about 2.5:1. The geared turbofan enables operation of the low spool 30 at higher speeds that can increase the operational efficiency of the LPC 44 and LPT 46 and render increased pressure in a fewer number of stages.

A pressure ratio associated with the LPT 46 is pressure measured prior to the inlet of the LPT 46 as related to the pressure at the outlet of the LPT 46 prior to an exhaust nozzle of the gas turbine engine 20. In one non-limiting embodiment, the bypass ratio of the gas turbine engine 20 is greater than about ten (10:1), the fan diameter is significantly larger than that of the LPC 44, and the LPT 46 has a pressure ratio that is greater than about five (5:1). It should be understood, however, that the above parameters are only exemplary of one embodiment of a geared architecture engine and that the present disclosure is applicable to other gas turbine engines including direct drive turbofans.

In one embodiment, a significant amount of thrust is provided by the bypass flow path B due to the high bypass ratio. The fan section 22 of the gas turbine engine 20 is designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low Corrected Fan Tip Speed is the actual fan tip speed divided by an industry standard temperature correction of (“T”/518.7^{0.5}), where “T” represents the ambient temperature in degrees Rankine. The Low Corrected Fan Tip Speed according to one non-limiting embodiment of the example gas turbine engine 20 is less than about 1150 fps (351 m/s).

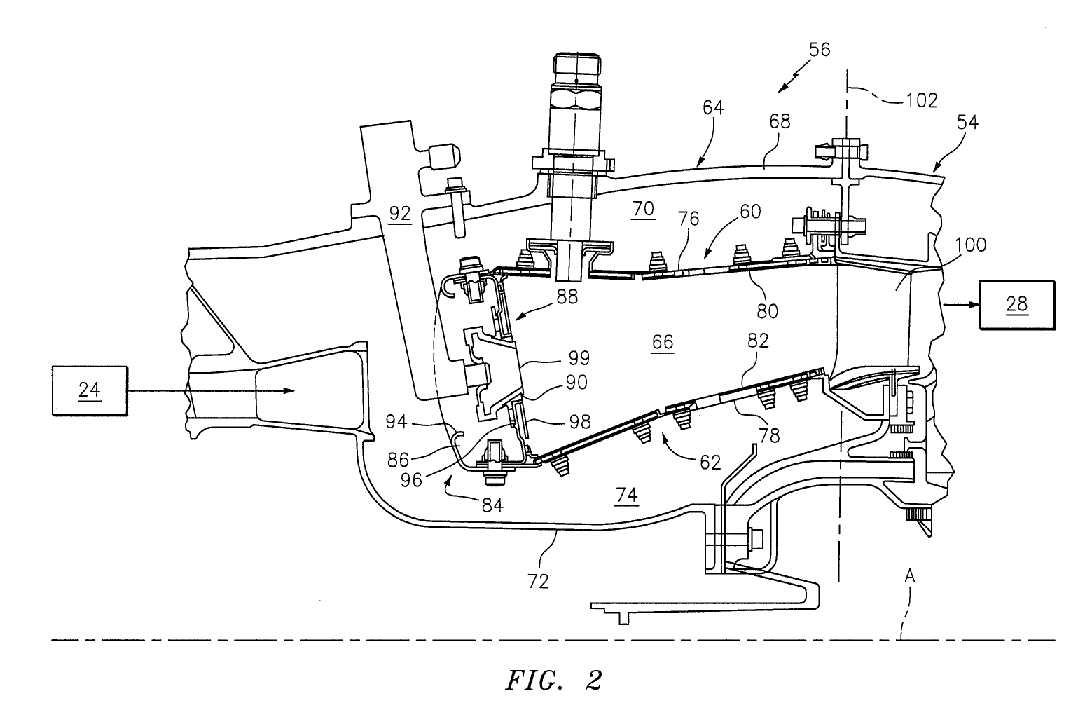

Referring to FIG. 2, the combustor section 26 generally includes an annular combustor 56 with an outer combustor wall assembly 60, an inner combustor wall assembly 62, and a diffuser case module 64 that surrounds assemblies 60, 62. The outer and inner combustor wall assemblies 60, 62 are generally cylindrical and radially spaced apart such that an annular combustion chamber 66 is defined therebetween. The outer combustor wall assembly 60 is spaced radially inward from an outer diffuser case 68 of the diffuser case module 64 to define an outer annular plenum 70. The inner wall assembly 62 is spaced radially outward from an inner diffuser case 72 of the diffuser case module 64 to define, in-part, an inner annular plenum 74. Although a particular combustor is illustrated, it should be understood that other combustor types with various combustor liner arrangements will also benefit. It is further understood that the disclosed cooling flow paths are but an illustrated embodiment and should not be so limited.

The combustion chamber 66 contains the combustion products that flow axially toward the turbine section 28. Each combustor wall assembly 60, 62 generally includes a respective support shell 76, 78 that supports one or more heat shields or liners 80, 82. Each of the liners 80, 82 may be formed of a plurality of floating panels that are generally rectilinear and manufactured of, for example, a nickel based super alloy that may be coated with a ceramic or other temperature resistant material, and are arranged to form a liner configuration mounted to the respective shells 76, 78.

The combustor 56 further includes a forward assembly 84 that receives compressed airflow from the compressor section 24 located immediately upstream. The forward assembly 84 generally includes an annular hood 86, a bulkhead assembly 88, and a plurality of swirlers 90 (one shown). Each of the swirlers 90 are circumferentially aligned with one of a plurality of fuel nozzles 92 (one shown) and a respective hood port 94 to project through the bulkhead assembly 88. The bulkhead assembly 88 includes a bulkhead support shell 96 secured to the combustor wall assemblies 60, 62 and a plurality of circumferentially distributed bulkhead heat shields or panels 98 secured to the bulkhead support shell 96 around each respective opening 99 defined by the swirlers 90. The bulkhead support shell 96 is generally annular and the plurality of circumferentially distributed bulkhead panels 98 are segmented, typically one to each fuel nozzle 92 and swirler 90.

The annular hood 86 extends radially between, and is secured to, the forwardmost ends of the combustor wall assemblies 60, 62. Each one of the plurality of circumferentially distributed hood ports 94 receives a respective on the plurality of fuel nozzles 92, and facilitates the direction of compressed air into the forward end of the combustion chamber 66 through the swirler opening 99. Each fuel nozzle 92 may be secured to the diffuser case module 64 and projects through one of the hood ports 94 into the respective swirler 90.

The forward assembly 84 introduces core combustion air into the forward section of the combustion chamber 66 while the remainder of compressor air enters the outer annular plenum 70 and the inner annular plenum 74. The plurality of fuel nozzles 92 and adjacent structure generate a blended fuel-air mixture that supports stable combustion in the combustion chamber 66.

Opposite the forward assembly 84, the outer and inner support shells 76, 78 are mounted adjacent to a first row of airfoil assemblies 100 in the HPT 54 and generally immediately aft of a combustor exit plane 102 orientated substantially normal to axis A. In the present, non-limiting example, the airfoil assemblies 100 are vanes and thus static engine components that direct core airflow combustion gases onto the turbine blades of the first turbine rotor in the turbine section 28 to facilitate the conversion of pressure energy into kinetic energy. The core airflow combustion gases are also accelerated by the airfoil assemblies or vanes 100 because of their convergent shape and are typically given a “spin” or a “swirl” in the direction of turbine rotor rotation. The turbine rotor blades absorb this energy to drive the turbine rotor at high speed. It is understood and contemplated that the term “airfoil assembly” means any airfoil with a combined platform having aft edges, thus airfoil assembly may include both vanes and blades and within any stage of the turbine section 28.

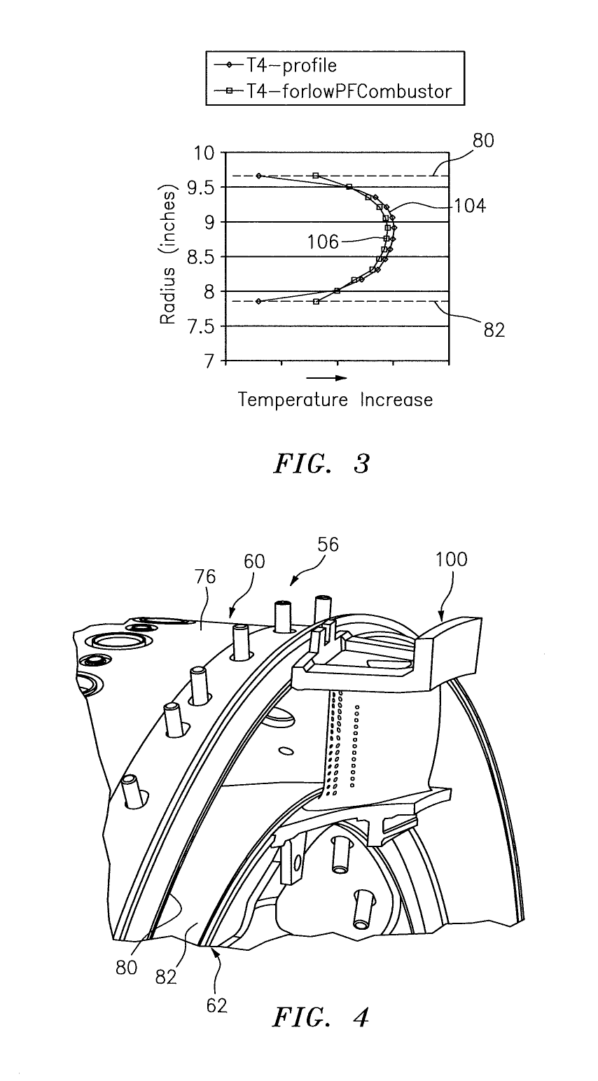

Referring to FIG. 3, a radial temperature profile of hot combustion air exiting the combustor 56 is illustrated on a radius versus temperature graph. That is, the temperature profile generally spans radially between the inner combustor liner 82 and the outer combustor liner 80 and within the combustor exit plane 102. More traditional profiles 104 depict cooler inner and outer extremities with higher temperatures therebetween that tend to be favorable for more traditional turbines with limited cooling at the extremities (e.g. tip and root) but with higher Pattern Factor. However, ever increasing demands placed on combustors 56 may require combustor designs that generate a low Pattern Factor, which will result in a temperature distribution 106 that is hotter at the extremities than the traditional high Pattern Factor combustors. These low Pattern Factor combustors 56 require additional cooling to tailor the profile at the exit of the vane 100 of the HPT 56, as one non-limiting example.

Referring to FIGS. 4 through 6, the first stage HPT vane 100 has an airfoil 108, an inner platform 110 and an outer platform or shroud 112. The airfoil is engaged to and spans radially between the platforms 110, 112 and spans circumferentially (and in an axial rearward direction) between forward and aft edges 114, 116 of the airfoil. When the HPT 56 is fully assembled, the platforms 110, 112 form with adjacent platforms of additional vanes 100 (not shown) foil ing respective rings that are radially aligned with and adjacent to the respective inner and outer liners 82, 80 of the combustor 56.

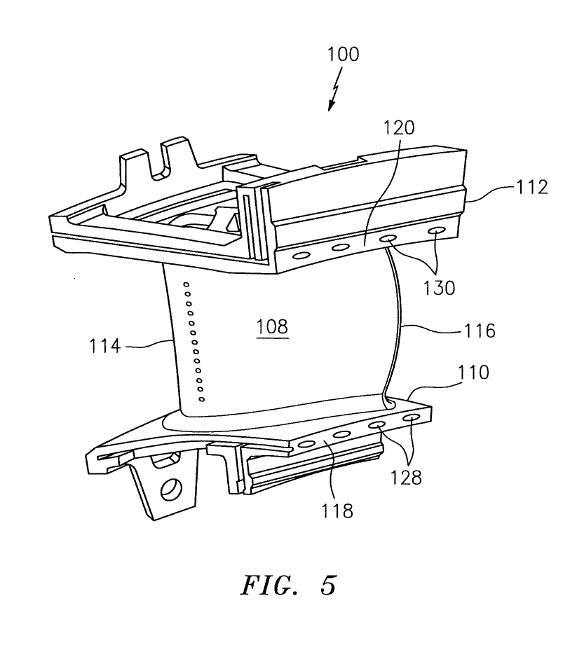

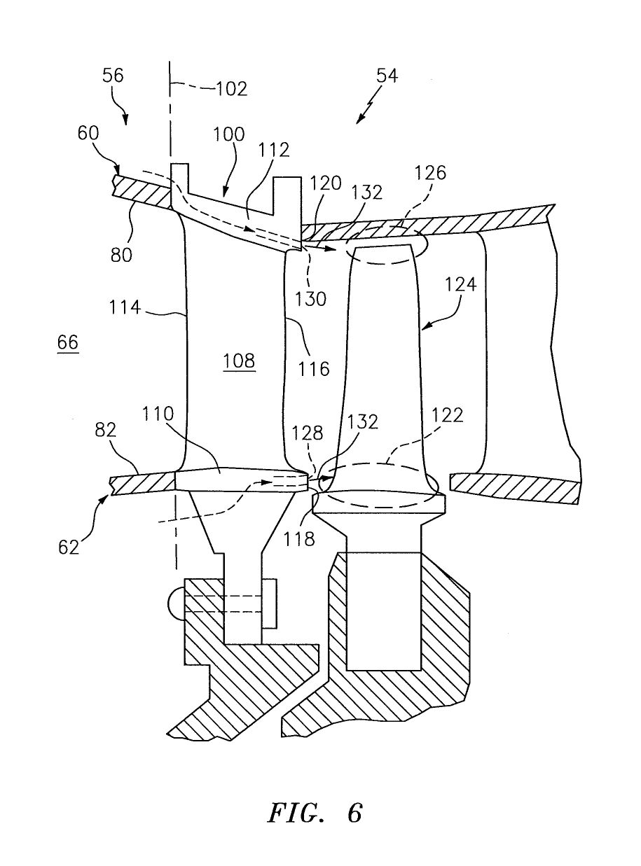

Each platform 110, 112 has respective aft edges 118, 120 that when fully assembled form annular surfaces carried by the rings (not shown) that generally lie within an imaginary plane normal to the axis A. The aft edge 118 of the inner platform 110 generally faces a root or platform region 122 of an adjacent rotating blade 124 and the aft edge 120 generally faces a tip region 126 of the blade 124. A plurality of cooling holes 128, 130 (four illustrated in each) communicate through each respective edge 118, 120 (See FIG. 5) for cooling the respective root and tip regions 122, 126 of the adjacent rotating blades 124. It is understood that the number of cooling holes 128, 130 may be greater or less than four and may be dictated by the cooling needs of the adjacent blade root and tip regions 122, 126. This additional cooling provided by holes 128, 130 may be fed from the vane cooling flow supply (inner or outer diameter supply from leading edge, mid-chord or trailing edge vane cooling supply), platform cooling flow feeds (inner or outer diameter), and/or from under the vane inner diameter platform cavity. The holes 128, 130 may also be angled to further direct cooling flow to the desired location on the adjacent blade 124. Moreover, the holes 128, 130 could be angled circumferentially to align the cooling flow with the swirling gaspath flow of the combustor 56 to reduce loses. That is, the gaspath flow may not be strictly in an axial direction but may also has a circumferential flow component. Angling of the holes circumferentially will align the cooling flow with the swirling flow of the gaspath flow.

Referring to FIG. 6 and in operation, cooling air, identified by arrows 132, may flow from the inner and outer plenums 70, 74, through any variety of passages or cavities at least partly in the vane 100, and out through the respective cooling holes 128, 130. The expelled cooling air is then directed toward the adjacent root and tip regions 122, 126 of the blade 124. It is understood that although such cooling is advantageous when utilized with combustors having low Pattern Factors, the cooling advantages may also be used for any vane in any turbine stage and regardless of the temperature profile and/or Pattern Factors (i.e. low or high) at the combustor exit plane.

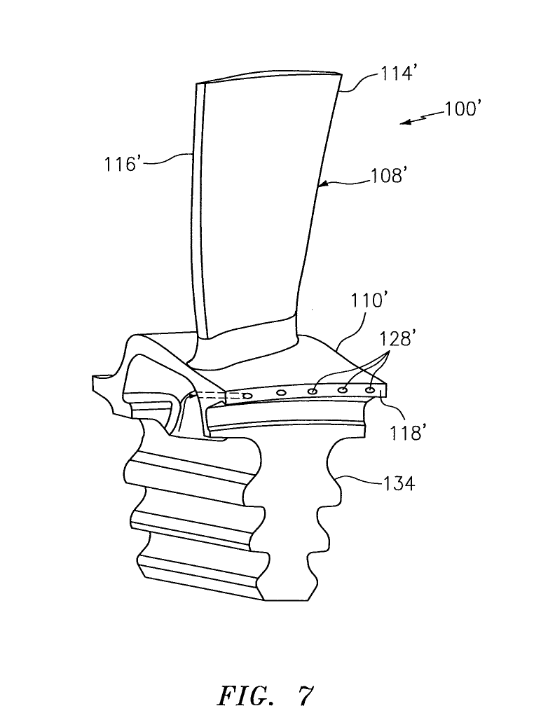

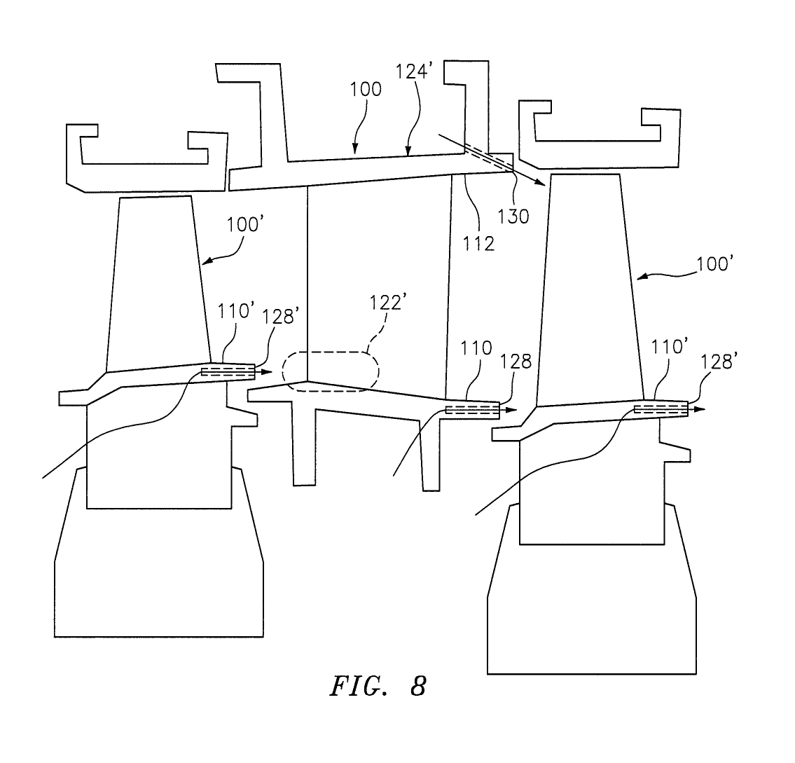

Referring to FIGS. 7 and 8, a second, non-limiting embodiment of an airfoil assembly is illustrated wherein like elements have like identifying numerals except with the addition of a prime symbol. In this embodiment, the airfoil assembly 100′ is a turbine blade having an airfoil 108′, and a platform 110′. The airfoil 108′ is engaged to and projects radially outward from the platform 110′ and spans circumferentially (and in an axial rearward direction) between forward and aft edges 114′, 116′ of the airfoil.

The platform 110′ has an aft edge 118′ that generally faces a root or platform region 122′ of an adjacent, downstream, stationary vane 124′. A plurality of cooling holes 128′ (five illustrated as a non-limiting example) communicate through the edge 118′ for cooling the respective root region 122′ of the adjacent stationary vane 124′ and/or reducing wake region turbulence. The cooling air flowing through holes 128′ may be fed from channels (not shown) in a blade fir tree 134 projecting radially inward from the platform 110′, or the cooling air may be fed from wheel cavities. It is further understood and contemplated that the aft edges of the platforms of both the vanes and axially adjacent blades may have cooling holes as a combined system of cooling. Moreover, the cooling holes may be any shape including round or orthogonal and may be any size, number and distributed density depending on the dynamic and cooling needs of the application.

It is understood that relative positional terms such as “forward,” “aft,” “upper,” “lower,” “above,” “below,” and the like are with reference to the normal operational attitude and should not be considered otherwise limiting.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. An airfoil assembly, comprising:
a first platform having an aft edge and a cooling hole communicating through the aft edge; and
an airfoil projecting outward from the first platform.

2. The airfoil assembly set forth in claim 1, wherein the first platform is an inner platform.

3. The airfoil assembly set forth in claim 2, wherein the assembly includes a blade.

4. The airfoil assembly set forth in claim 1, wherein the cooling hole is angled circumferentially.

5. The airfoil assembly set forth in claim 1, further comprising:
a second platform with the airfoil spanning between the first and second platforms, wherein the airfoil assembly includes a vane.

6. The airfoil assembly set forth in claim 1, wherein the aft cooling hole is one of a plurality of cooling holes spaced along the aft edge.

7. The airfoil assembly set forth in claim 5, wherein the second platform includes a second aft edge with at least one cooling hole communicating therethrough.

8. The airfoil assembly set forth in claim 7, wherein the assembly is a first stage vane.

9. A gas turbine engine, comprising:
a combustor constructed and arranged to produce hot combustor gases;
a turbine disposed aft of the combustor and having a vane for directing the hot combustor gases and a blade disposed aft of the vane,
wherein the vane has a platform having an aft edge and a cooling hole communicating through the aft edge for cooling the blade.

10. The gas turbine engine set forth in claim 9, wherein the hot combustor gases have a low Pattern Factor.

11. The gas turbine engine set forth in claim 9, wherein the platform is an inner platform and the blade includes a root region disposed downstream of and proximate to the aft edge.

12. The gas turbine engine set forth in claim 9, further comprising:
the platform being an outer platform; and,
wherein a tip region of the blade is disposed downstream of and proximate to the aft edge.

13. The gas turbine engine set forth in claim 9, further comprising:
the vane having an airfoil and a second platform wherein the airfoil spans radially between the platform and the second platform; and
wherein the second platform has an aft edge and a cooling hole communicating through the aft edge of the second platform.

14. The gas turbine engine set forth in claim 13, wherein the vane and blade are a high pressure turbine first stage vane and blade.

15. A method of cooling a turbine airfoil, comprising:
flowing cooling air through a hole in an aft edge of a platform of an airfoil assembly disposed upstream of the turbine airfoil.

16. The method according to claim 15, further comprising:
cooling a root region of the turbine airfoil.

17. The method according to claim 15, wherein the turbine airfoil is a blade and the airfoil assembly is a vane.

18. The method according to claim 17, further comprising:
cooling a tip region of the blade.

19. The method according to claim 15, further comprising:
cooling a tip region of the turbine airfoil.
